(19) United States
(12) Patent Application Publication
(10) Pub. No.: US 2025/0222706 A1
(43) Pub. Date: Jul. 10, 2025

(54) INKJET IMAGE FORMING APPARATUS

(71) Applicant: Konica Minolta, Inc., Tokyo (JP)

(72) Inventors: Satoru NAKAMURA, Tokyo (JP); Kenichi YAMAMOTO, Tokyo (JP)

(21) Appl. No.: 18/990,170

(22) Filed: Dec. 20, 2024

(30) Foreign Application Priority Data
Jan. 5, 2024 (JP) 2024-000783

(51) Int. Cl. B41J 25/00

(52) U.S. Cl. CPC B41J 25/001

(57) ABSTRACT

In an inkjet image forming apparatus, a head module is provided in a mounting base so as to be positionally adjustable in a first direction, and an adjustment member is provided in the mounting base so as to be movable in a second direction intersecting the first direction. The adjustment member includes an abutting portion that makes into contact with an abutted portion on the head module side, and the first biasing member biases the abutted portion to the abutting portion side. At least one of the abutted portions and the abutting portion is an inclined surface inclined with respect to the second direction.

### CROSS REFERENCE TO RELATED APPLICATIONS

The present invention claims priority under 35 U.S.C. § 119 to Japanese Patent Application No. 2024-000783 filed on Jan. 5, 2024, the entire content of which is incorporated herein by reference.

### BACKGROUND

### Technological Field The present invention relates to an inkjet image forming apparatus.

### Description of Related Art

In an inkjet image forming apparatus, a head module to eject ink onto a recording medium is positionally adjustable in a first direction relative to a mounting base. For example, as disclosed in Japanese Unexamined Patent Publication No. 2018-94821, an operation member (referred to as an adjustment screw in Japanese Unexamined Patent Publication No. 2018-94821) is provided in a mounting base so as to be movable in a second direction orthogonal to a first direction via a reference block. The operation member includes a threaded portion at an intermediate portion thereof.

An adjustment block for adjusting the position of the head module in the first direction is provided in a screwed manner in the screw of the operation member, and the adjustment block includes a screw hole for screwing the screw of the operation member. The adjustment block is configured to be non-rotatable with respect to the reference block (the mounting base). The adjustment block includes an abutting portion (referred to as an inclined surface in Japanese Unexamined Patent Publication No. 2018-94821) that makes contact with an abutted portion (referred to as an inclined surface of the moving body in Japanese Unexamined Patent Publication No. 2018-94821) on the head module side.

A ball plunger that biases the abutted portion toward the abutting portion is provided at an appropriate position in the mounting base. In order to convert the movement of the operation member in the second direction into the movement of the head module in the first direction, each of the abutted portion on the head module side and the abutting portion of the adjustment block is an inclined surface inclined with respect to the second direction. The inclined surface of the abutting portion of the adjustment block is inclined in a direction opposite to the inclined surface of the abutted portion of the head module side.

With the above configuration, when the operation member is rotated by a rotating operation, the adjustment block moves in the second direction (the axial direction of the operation member) by the screwing action of the screw of the operation member and the screw hole of the adjustment block. Then, the head module moves in the first direction in a state in which the contact between the abutted portion on the head module side and the abutting portion of the adjustment block is maintained with the biasing force of the ball plunger. In this manner, it is possible to adjust the position of the head module in the first direction with respect to the mounting base.

### SUMMARY

Incidentally, since the operation member and the adjustment block including the abutting portion are separate components, rattling is likely to occur between the operation member and the abutting portion of the adjustment block when the adjustment block is attached to the operation member. When the adjustment block moves in the second direction by a screwing action between the screw of the operation member and the screw hole of the adjustment block, a slight eccentric movement of the contact part of the adjustment block with respect to the axial center of the operation member occurs. Therefore, even when the operation member is moved in the second direction by the rotation operation, it is difficult to adjust the position of the head module in the first direction with respect to the mounting base with high accuracy.

In view of this, an object of the present invention is to provide an ink jet image forming apparatus that can adjust the position of the head module with respect to the mounting base in the first direction with high accuracy.

In order to achieve at least one of the above-mentioned objects, an inkjet image forming apparatus reflecting one aspect of the present invention includes: a head module provided on a mounting base so as to be positionally adjustable in a first direction; an adjustment member that is provided on the mounting base so as to be movable in a second direction intersecting the first direction, adjusts a position of the head module in the first direction, and includes an abutting portion that abuts an abutted portion on a side of the head module; and a first biasing member that biases the abutted portion toward the abutting portion. At least one of the abutted portion and the abutting portion is an inclined surface inclined with respect to the second direction such that a movement of the adjustment member in the second direction is converted into a movement of the head module in the first direction.

### BRIEF DESCRIPTION OF DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a schematic perspective view of an inkjet image forming apparatus according to the present embodiment,

FIG. 2 is a schematic bottom view of a head unit, illustrating a state where a plurality of inkjet heads are attached to a carriage,

FIG. 3 is a schematic perspective view of a head module attached to the carriage,

FIG. 4 is a schematic front view of the head module attached to the carriage,

FIG. 5 is a schematic side view of the head module attached to the carriage,

FIG. 6 is a schematic bottom view of the head module attached to the carriage,

FIG. 7 is a cross-sectional view taken along line VII-VII in FIG. 4,

FIG. 8 is an enlarged view of a portion VIII in FIG. 4; and

FIG. 9 is a cross-sectional view taken along line IX-IX in FIG. 8.

### DETAILED DESCRIPTION OF EMBODIMENTS

Hereinafter, one or more embodiments of the present invention will be described with reference to the drawings. However, the scope of the invention is not limited to the disclosed embodiments.

Hereinafter, the present embodiment will be described with reference to the drawings. In the present embodiment, the conveyance direction refers to a conveyance direction in which a recording medium is conveyed. The downstream side is a downstream side in the transport direction, and the upstream side is an upstream side in the transport direction. In the present embodiment, the X-axis direction is the main scanning direction, and is a direction orthogonal to the conveyance direction. The Y-axis direction refers to a sub-scanning direction and a conveyance direction. The Z-axis direction is a direction orthogonal to the X-axis direction and the Y-axis direction. The Z-axis direction corresponds to a first direction, and the Y-axis direction corresponds to a second direction. In the present embodiment, the second direction is a direction orthogonal to the first direction, but may not be a direction orthogonal to the first direction as long as it is a direction intersecting the first direction.

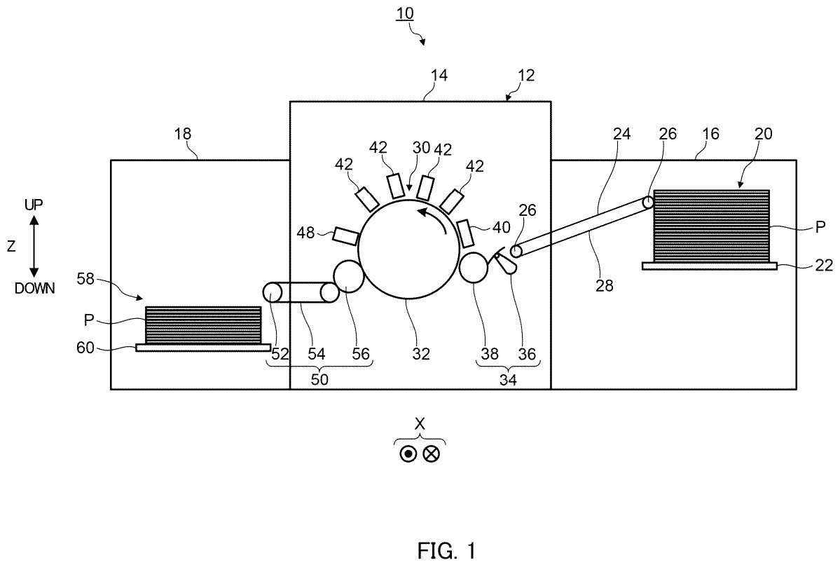

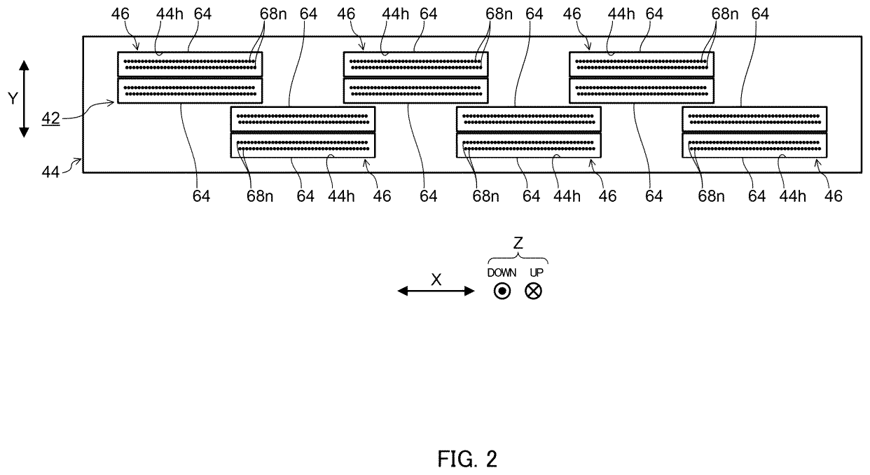

The following describes an overall configuration of an inkjet image forming apparatus 10 according to the present embodiment with reference to FIG. 1 and FIG. 2. FIG. 1 is a schematic front view of the inkjet image forming apparatus 10 according to the present embodiment. FIG. 2 is a schematic bottom view of a head unit 42 according to the embodiment, and illustrates a state where the plurality of head modules 46 are attached to a carriage 44.

As illustrated in FIG. 1, the inkjet image forming apparatus 10 according to the present embodiment is a single-pass recording apparatus that forms a color image on a recording medium P by ejecting inks of four colors toward the recording medium P at appropriate timings while moving the recording medium P in a conveyance direction. As the recording medium P, in addition to paper such as plain paper or coated paper, it is possible to use various media such as a fabric or a resin film on which the ink landed on the surface can be fixed. In the inkjet image forming apparatus 10, ink is used that undergoes a phase change between a gel and a sol (liquid) depending on the temperature. For example, it is possible to use energy ray irradiation type ink such as UV ink which is in a gel state at room temperature, is changed to a sol state by being heated, and is solidified by being irradiated with energy rays at the time of image formation.

The inkjet image forming apparatus 10 includes an apparatus main body 12. The apparatus main body 12 includes a center frame 14, a first side frame 16 disposed on one side of the center frame 14, and a second side frame 18 disposed on the other side of the center frame 14.

The first side frame 16 is provided with a sheet feeder 20 for feeding a recording medium P. The sheet feeder 20 includes a sheet feed tray 22 which has a plate shape and on which the recording medium P is to be placed, and the sheet feed tray 22 is disposed at the first side frame 16 so as to be movable in the up-down direction. The sheet feed tray 22 is configured to move up and down according to the amount of recording media P to be placed, and the topmost recording medium P is held at a predetermined height position.

The sheet feeder 20 includes a conveyer 24 for transporting the recording medium P fed from the paper feed tray 22 in the transport direction, and the conveyer 24 is provided from the first side frame 16 to the center frame 14. The conveyer 24 includes a plurality of rotatable support rollers 26 and an endless belt 28 provided so as to be wound around the plurality of support rollers 26. The belt 28 circulates by rotation of the plurality of support rollers 26, thereby conveying the recording medium P fed from the sheet feed tray 22 in the conveyance direction.

The center frame 14 is provided with an image former 30 for forming an image by ejecting ink onto the recording medium P. The image former 30 includes an image forming drum 32 that carries the recording medium P, and the image forming drum 32 is rotatably provided on the center frame 14. In a state where the recording medium P is borne on an outer peripheral surface (conveying surface) of the image forming drum 32, the image forming drum 32 is rotated by driving of a motor (unillustrated) for the image forming drum, by which the recording medium P is conveyed in a conveying direction. Note that the image forming drum 32 includes a claw (not illustrated) to press an edge portion of the recording medium P and an attraction portion (not illustrated) to attract the recording medium P.

The image former 30 has a deliverer 34 for delivering the recording medium P from the conveyer 24 to the image forming drum 32, and the deliverer 34 is provided between the conveyer 24 and the image forming drum 32 in the center frame 14. The deliverer 34 includes a swing arm 36 that carries one end of the recording medium P conveyed by the conveyer 24, and a delivery drum 38 that hands over the recording medium P carried by the swing arm 36 to the image forming drum 32. One end of the recording medium P on the conveyer 24 is carried by the swing arm 36 and the recording medium P is delivered to the delivery drum 38, so that the recording medium P is delivered from the delivery drum 38 to the image forming drum 32.

The image former 30 has a medium heater 40 for heating the recording medium P carried on the image forming drum 32, and the medium heater 40 is provided on the downstream side of the delivery drum 38 in the center frame 14. The medium heater 40 is disposed facing the outer circumferential surface of the image forming drum 32. The medium heater 40 includes, for example, an infrared heater or the like, and heats the image forming drum 32 and the recording medium P so that the recording medium P conveyed by the image forming drum 32 has a temperature within a predetermined range.

As illustrated in FIG. 1 and FIG. 2, the image former 30 has a plurality of head units 42 that form an image by ejecting ink onto the recording medium P carried on the image forming drum 32, and the plurality of head units 42 are disposed on the downstream side of the medium heater 40. The plurality of head units 42 are units corresponding to inks of four colors of yellow (Y), magenta (M), cyan (C), and black (K). The plurality of head units 42 corresponding to the inks of four colors of Y, M, C, and K are arranged at intervals along the transport direction from the upstream side. Each head unit 42 is held by each carriage 44 movably provided in the main scanning direction in the center frame 14. In other words, each head unit 42 is provided on the center frame 14 so as to be movable in the main scanning direction via each carriage 44. Each carriage 44 is made of, for example, an aluminum alloy.

Each head unit 42 includes a plurality of head modules 46 to eject ink onto the recording medium P, and the plurality of head modules 46 are provided on the carriage 44 as a mounting base so that the positions thereof are adjustable in the Y-axis direction. The plurality of head modules 46 are arranged, for example, in a staggered manner along the main scanning direction (X-axis direction). In other words, each head unit 42 constitutes a line head including a plurality of head modules 46.

As illustrated in FIG. 1, the image former 30 has a fixer 48 for fixing the ink to the recording medium P, and the fixer 48 is provided on the downstream side of the plurality of head units 42 in the center frame 14. The fixer 48 is disposed facing the outer peripheral surface of the image forming drum 32. The fixer 48 includes a light emitter that emits energy rays such as ultraviolet rays. The light emitter of the fixer 48 applies predetermined energy to the ink ejected onto the recording medium P, thereby curing and fixing the ink onto the recording medium P.

The image former 30 includes a deliverer 50 that transports the recording medium P, which has been irradiated with the energy rays, from the image forming drum 32 in a transport direction. The deliverer 50 is provided from the center frame 14 to the second side frame 18. The deliverer 50 includes a plurality of rotatable support rollers 52, an endless belt 54 provided so as to be wound around the plurality of support rollers 52, and a delivery drum 56 that delivers the recording medium P from the image forming drum 32 to the belt 54. The belt 54 circulates by rotation of the plurality of support rollers 52, thereby conveying the recording medium P fed from the image forming drum 32 in a conveyance direction.

The second side frame 18 is provided with a sheet ejector 58 for ejecting the recording medium P on which an image has been formed. The sheet ejector 58 includes a plate-like paper ejection tray 60 for placing the recording medium P on which an image has been formed. The sheet ejector 58 stores the recording medium P therein until a user removes the recording medium P from the sheet ejection tray 60.

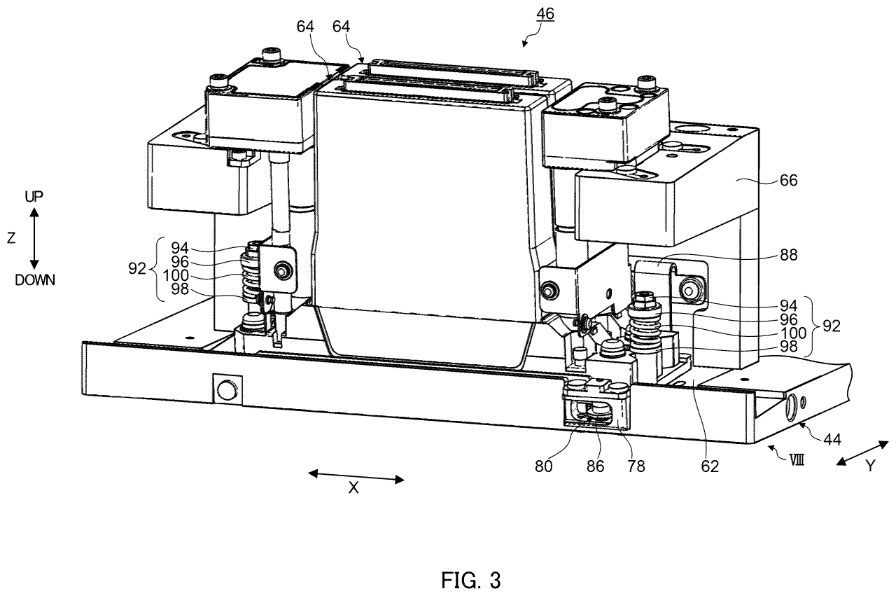

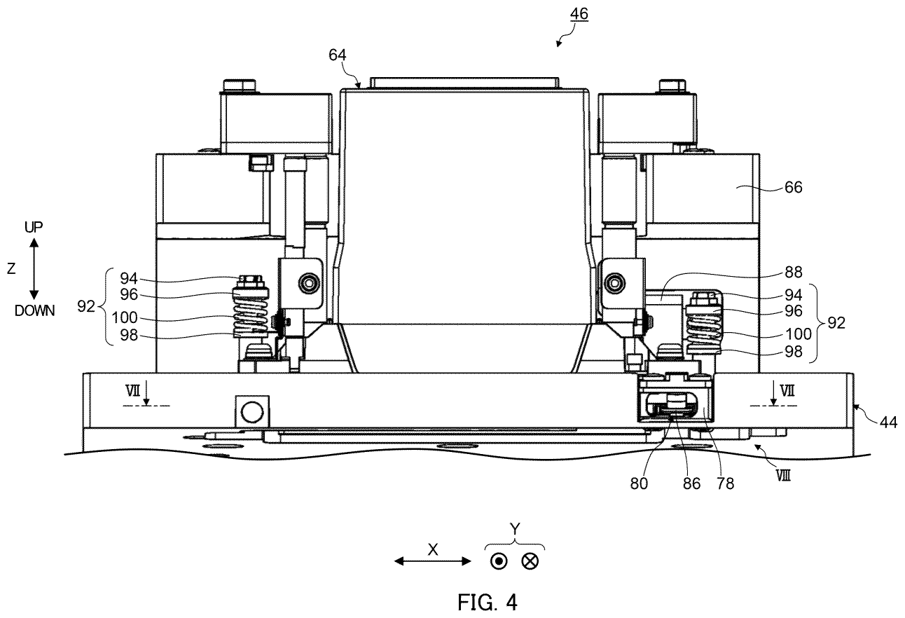

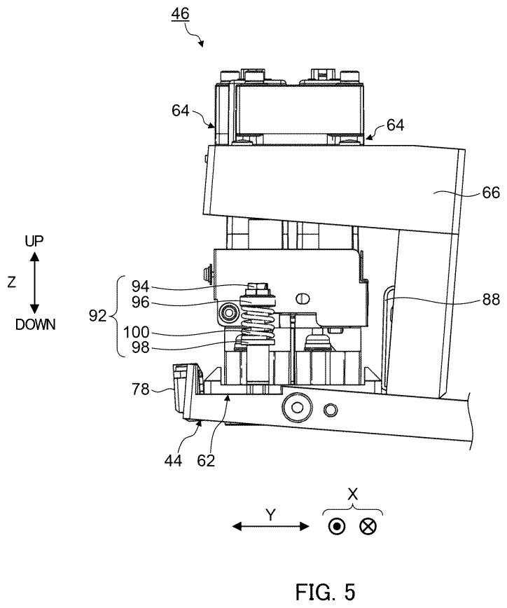

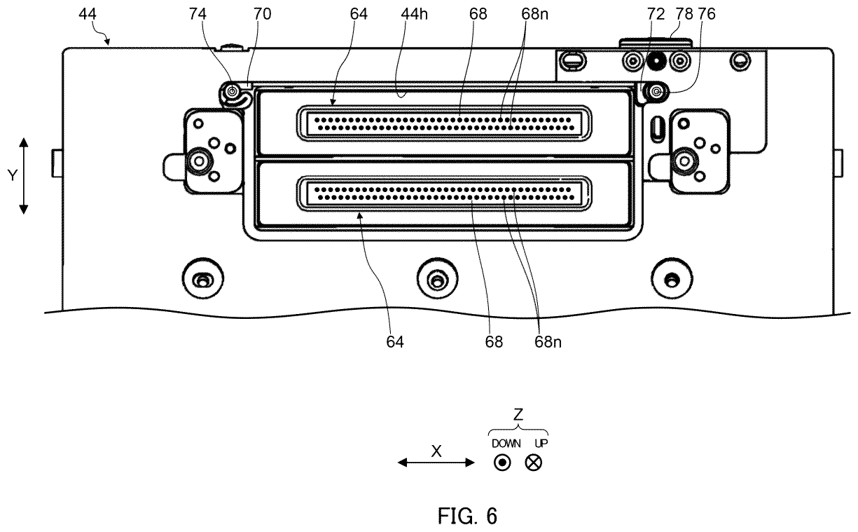

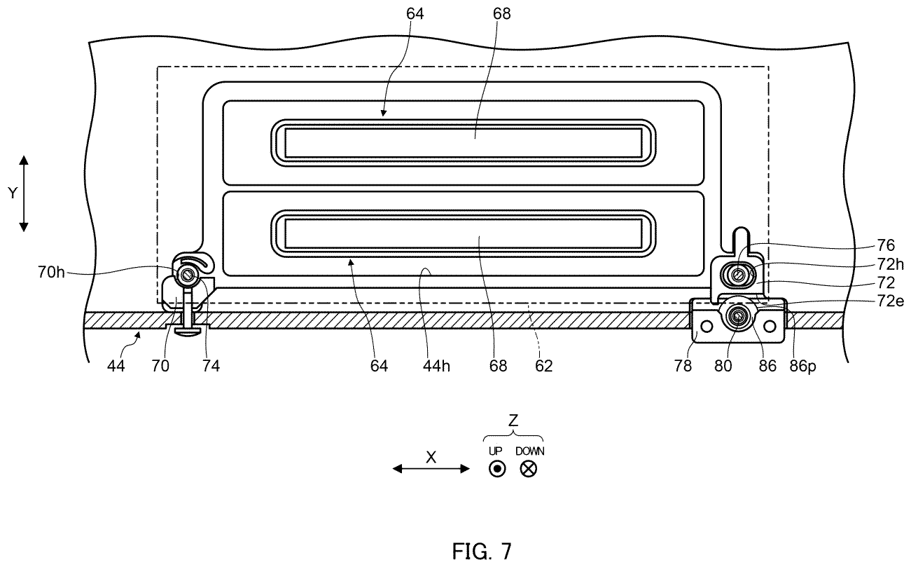

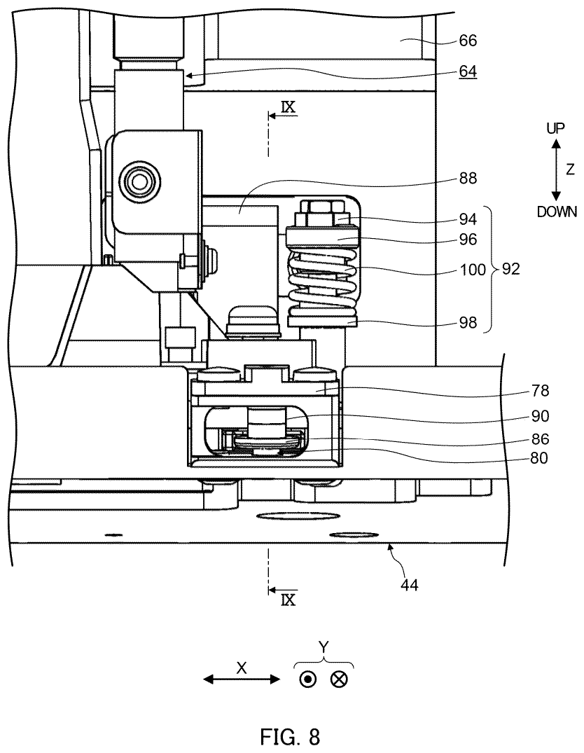

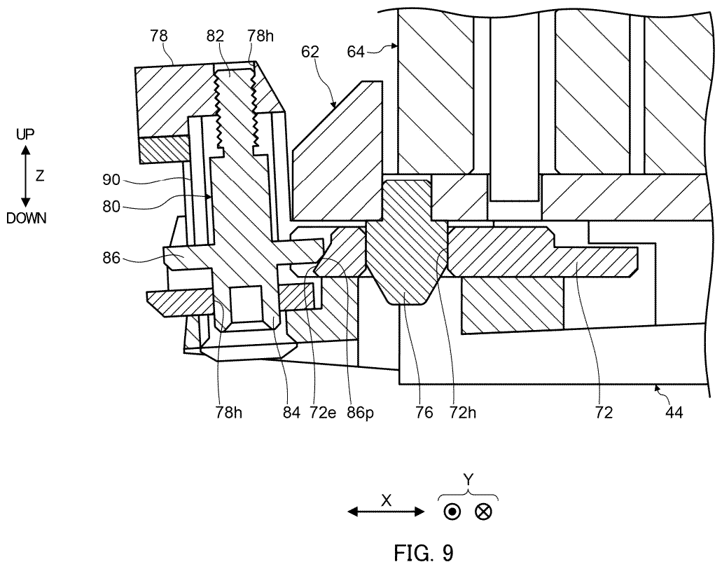

Subsequently, with reference to FIGS. 3 to FIG. 9, a specific configuration of the head module 46 according to the present embodiment is described. FIG. 3 is a schematic perspective view of the head module 46 attached to the carriage 44. FIG. 4 is a schematic front view of the head module 46 attached to the carriage 44. FIG. 5 is a schematic side view of the head module 46 attached to the carriage 44. FIG. 6 is a schematic bottom view of the head module 46 attached to the carriage 44. FIG. 7 is a cross-sectional view taken along line VII-VII in FIG. 4. FIG. 8 is an enlarged view of a portion VIII in FIG. 4. FIG. 9 is a cross-sectional view taken along line IX-IX in FIG. 8. Note that FIGS. 3 to FIG. 9 conceptually illustrate a part of the carriage 44.

As illustrated in FIGS. 3 to FIG. 6, as described above, the head module 46 according to the embodiment is provided on the carriage 44 as the mounting base so that the position thereof can be adjusted in the Y-axis direction, and closes the 2 h of the through hole formed in the carriage 44. In addition, the head module 46 includes a plate-shaped module base 62 which is provided on the carriage 44 so that the position thereof can be adjusted in the Y axis direction, and a plurality of ink jet heads 64 which are provided on the module base 62 and eject ink. Upper portions of the plurality of inkjet heads 64 are supported by a support member 66 fixed to the carriage 44. Note that the support member 66 may be regarded as a member constituting part of the carriage 44.

Each inkjet head 64 has a common ink chamber (not illustrated) for storing ink therein, and the common ink chamber is connected to an ink supply device (not illustrated) for supplying ink. Furthermore, each inkjet head 64 has a head chip 68 on its bottom surface side, and the head chip 68 has a plurality of nozzles 68n for ejecting ink.

In the head chip 68, a plurality of pressure chambers (not illustrated) are formed for the respective nozzles 68n, and each pressure chamber communicates with the common ink chamber and the corresponding nozzle 68n. Each pressure chamber is configured to be pressurized by driving of a drive element (not illustrated) such as a piezoelectric element or a heating element. Each nozzle 68n is configured to eject (discharge) ink when the corresponding pressure chamber is pressurized.

The head module 46 and the like have the following configuration in order that the position of the head module 46 can be adjusted in the Y-axis direction with respect to the carriage 44 that is a mounting base.

As illustrated in FIG. 6 and FIG. 7, a first positioning member 70 is provided on the edge side of the carriage 44 in the Y-axis direction, and the first positioning member 70 has a first positioning hole 70h corresponding to a circular hole. In other words, the first positioning hole 70h is provided on the edge portion side of the carriage 44 in the Y axis direction via the first positioning member 70. In addition, a second positioning member 72 is provided so as to be movable in the Y axis direction at a position separated in the X axis direction from the first positioning member 70 on the edge portion side of the carriage 44 in the Y axis direction. The second positioning member 72 has a second positioning hole 72h that is an elongated hole extending in the X-axis direction.

The head module 46 has a first positioning pin 74 provided on the bottom surface of the module base 62, and the first positioning pin 74 engages with the first positioning hole 70h of the first positioning member 70. When the first positioning pin 74 is engaged with the first positioning hole 70h of the first positioning member 70, the movement of the head module 46 in the Y-axis direction is converted into a rotational movement (movement in the rotational direction) around the first positioning pin 74.

The head module 46 has a second positioning pin 76 provided at a position separated in the X-axis direction from the first positioning pin 74 on the bottom surface of the module base 62, and the second positioning pin 76 engages with the second positioning hole 72h of the second positioning member 72. Since the second positioning pin 76 is engaged with the second positioning hole 72h of the second positioning member 72, the second positioning pin 76 moves in the X-axis direction along the second positioning hole 72h of the second positioning member 72 during the rotational movement of the head module 46.

As illustrated in FIGS. 7 to FIG. 9, a block body 78 is provided in the vicinity of the second positioning member 72 in the edge portion of the carriage 44 in the Y axis direction, and both sides of the block body 78 in the Y axis direction are opened (released). A screw hole 78b is formed in an upper part of the block body 78, and a fitting hole 78h is formed in a lower part of the block body 78. In other words, the screw hole 78b and the fitting hole 78h are provided in the respective edge portions of the carriage 44 in the Y-axis direction via the block bodies 78. The block body 78 may be regarded as a member constituting a part of the carriage 44.

As illustrated in FIG. 9, the block body 78 is provided with a vertical-shaft-shaped adjustment member 80 for adjusting the position of the head module 46 in the Y-axis direction so as to be movable in the Z-axis direction. In other words, the adjustment member 80 is provided at an edge portion of the carriage 44 in the Y-axis direction so as to be movable in the Z-axis direction via the block body 78. Furthermore, the adjustment member 80 has, at its upper part, a screw 82 to be screwed into the screw hole 78b of the block body 78 (the screw hole 78b of the carriage 44). The adjustment member 80 moves in the Z-axis direction by a rotating operation of a tool (not illustrated) connected from one side in the Z-axis direction. The adjustment member 80 has, at its lower part, a fitting part 84 that fits in the fitting hole 78h of the block body 78 (the fitting hole 78h of the carriage 44) so as to be movable in the Z-axis direction. Note that the adjustment member 80 is configured such that a tool can be connected thereto from one side in the Z-axis direction, but may be configured such that a tool can be connected thereto from the other side in the Z-axis direction.

The adjustment member 80 has an annular flange 86 in its middle part and in a part close to the engagement part 84, and an outer peripheral surface 86p of the flange 86 abuts on an end surface 72e in the Y-axis direction that is a part of the second positioning member 72. The end surface 72e of the second positioning member 72 in the Y-axis direction is an abutted portion on the head module 46 side, and the outer peripheral surface 86p of the flange 86 is an abutting portion that abuts against the abutted portion on the head module 46 side. A length between the outer peripheral surface 86p of the flange 86 and the fitter 84 in the Z-axis direction is shorter than a length between the outer peripheral surface 86p of the flange 86 and the screw 82 in the Z-axis direction.

As illustrated in FIGS. 3 to FIG. 5, a plate spring 88 serving as a first biasing member that biases the head module 46 to one side in the Y-axis direction is provided on the lower part of the support member 66. The plate spring 88 biases the head module 46 toward one side in the Y-axis direction, thereby biasing the end surface 72e of the second positioning member 72 in the Y-axis direction toward the outer peripheral surface 86p of the flange 86 of the adjustment member 80. As illustrated in FIG. 9, a coil spring 90 serving as a second biasing member that biases the outer peripheral surface 86p of the flange 86 toward the end surface 72e of the second positioning member 72 in the Y-axis direction is provided between the flange 86 and the upper portion of the block body 78 in the adjustment member 80.

As illustrated in FIG. 9, the end surface 72e of the second positioning member 72 is an inclined surface that is inclined with respect to the Y-axis direction such that the movement of the adjustment member 80 in the Z-axis direction is converted into the movement of the head module 46 in the Y-axis direction. The outer peripheral surface 86p of the flange 86, which is an abutting portion, is an R surface. The outer peripheral surface 86p of the flange 86 may be an inclined surface or an edge (pointed surface) inclined in a direction opposite to the end surface 72e of the second positioning member 72 instead of the R surface. When the outer peripheral surface 86p of the flange 86 as the abutting portion is an R surface or an edge, the hardness of the end surface 72e in the Y-axis direction of the second positioning member 72 as the abutted portion is higher than the hardness of the outer peripheral surface 86p of the flange 86.

The amount of movement of the head module 46 in the Y-axis direction is smaller than the amount of movement of the adjustment member 80 in the Z-axis direction. The amount of movement of the head module 46 in the Y-axis direction is proportional to the amount of movement of the adjustment member 80 in the Z-axis direction. Further, as described above, the movement of head module 46 in the Y-axis direction is converted into the rotational movement around first positioning pin 74.

With the above-described configuration, when the adjustment member 80 is rotated, the adjustment member 80 moves in the Z-axis direction by the screwing action of the screw 82 of the adjustment member 80 and the screw hole 78b of the block body 78. Then, in a state in which the contact between the outer circumferential surface 86p of the flange 86 and the end surface 72e of the second positioning member 72 is maintained by the biasing forces of the plate spring 88 and the coil spring 90, the head module 46 performs a rotational movement about the first positioning pin 74 while moving in the Y-axis direction. Thus, the position of the head module 46 can be adjusted in the Y-axis direction with respect to the carriage 44, and the inclination of the head module 46 with respect to the X-axis direction (the longitudinal direction of the carriage 44) can be adjusted.

As illustrated in FIGS. 3 to FIG. 5, pressers 92 that press the head module 46 toward the carriage 44 by an elastic force are provided on both sides of the head module 46 in the X-axis direction in the carriage 44, respectively. A specific configuration of each presser 92 is as follows.

As illustrated in FIGS. 3 to FIG. 5, and FIG. 8, a screw member 94 is screwed and provided on one side or the other side in the X-axis direction of the head module 46 in the carriage 44, and the screw member 94 has a head part 96 at its upper end part. The screw member 94 is provided with a movable ring 98 that makes into contact with an end portion of the module base 62 in the X-axis direction so as to be movable in the Z-axis direction (the axial direction of the screw member 94).

A coil spring 100 serving as a pressing member for pressing the movable ring 98 toward the module base 62 by an elastic force is provided between the head 96 of the screw member 94 and the movable ring 98. When the coil spring 100 presses the movable ring 98 toward the module base 62 by the elastic force, the head module 46 is pressed toward the carriage 44 by the elastic force. By changing the fastening amount of the screw member 94, the pressing force of the presser 92 can be adjusted. The pressing force of the presser 92 is set to a pressing force that does not hinder the position adjustment of the head module 46 in the Y-axis direction. FIGS. 3 to FIG. 5 and FIG. 8 illustrate a state before the movable ring 98 is pressed toward the module base 62.

With the structure of the inkjet image forming apparatus 10 according to the present embodiment, as described above, the adjustment member 80 is provided at the edge portion of the carriage 44 in the Y-axis direction via the block body 78 so as to be movable in the Z-axis direction. The adjustment member 80 has the outer peripheral surface 72e of the flange 86 as an abutting portion that abuts against the abutted portion (the end surface 86p of the second positioning member 72 in the Y-axis direction) on the head module 46 side. Therefore, the adjustment member 80 has a function as an operation member according to the prior art and a function as an adjustment block according to the prior art. Thus, rattling does not occur between the main body of the adjustment member 80 and the outer circumferential surface 86p of the flange 86, and the outer circumferential surface 86p of the flange 86 does not eccentrically move with respect to the axial center of the adjustment member 80. As a result, according to the embodiment, it is possible to adjust the position of the head module 46 in the Y axis direction with respect to the carriage 44 with high accuracy.

In the configuration of the inkjet image forming apparatus 10 according to the present embodiment, as described above, the plurality of plate springs 88 urge the end surface 72e of the second positioning member 72 in the Y-axis direction toward the outer peripheral surface 86p of the flange 86 of the adjustment member 80. The coil spring 90 biases the outer peripheral surface 86p of the flange 86 toward the end surface 72e of the second positioning member 72 in the Y-axis direction. Therefore, the contact between the outer peripheral surface 86p of the flange 86 and the end surface 72e of the second positioning member 72 can be stably maintained. Thus, according to the present embodiment, the position of the head module 46 can be adjusted with respect to the carriage 44 in the Y-axis direction with high accuracy and stability.

With the configuration of the inkjet image forming apparatus 10 according to the present embodiment, as described above, the movement of the head modules 46 in the Y-axis direction is converted into the rotational movement about the first positioning pins 74. Therefore, according to the embodiment, it is possible to adjust the inclination of the head module 46 with respect to the X-axis direction with high accuracy.

In the configuration of the inkjet image forming apparatus 10 according to the present embodiment, the end surface 72e of the second positioning member 72 in the Y-axis direction serves as an abutted portion on the head module 46 side. Therefore, it is possible to process the abutted portion on the head module 46 side into the inclined surface inclined with respect to the Y-axis direction with high accuracy. In this way, according to the embodiment, it is possible to adjust the position of the head module 46 with respect to the carriage 44 with higher accuracy in the Y axis direction.

According to the configuration of the inkjet image forming apparatus 10 according to the present embodiment, as described above, the second positioning hole of the second positioning member 72 extends in the X-axis direction. Therefore, during the rotational movement of the head module 46, the second positioning pin 76 moves in the X-axis direction along the second positioning hole 72h of the second positioning member 72. Accordingly, according to the embodiment, it is possible to stably adjust the inclination of the head module 46 with respect to the X-axis direction with high accuracy.

With the configuration of the inkjet image forming apparatus 10 according to the present embodiment, when the outer peripheral surface 86p of the flange 86 is an R surface or an edge, the hardness of the end surface 72e of the second positioning member 72 in the Y-axis direction is higher than the hardness of the outer peripheral surface 86p of the flange 86. Therefore, according to the embodiment, it is possible to suppress wear or the like of the end surface 72e in the Y axis direction of the second positioning member 72 which is the abutted portion on the head module 46 side.

With the configuration of the inkjet image forming apparatus 10 according to the present embodiment, as described above, the adjustment member 80 has the fitter 84 that fits in the fitting hole 78h of the carriage 44 so as to be movable in the Z-axis direction. Therefore, it is possible to suppress the runout of the adjustment member 80 during the movement thereof in the Z-axis direction. In particular, when the interval between the outer peripheral surface 86p of the flange 86 and the fitter 84 in the Z-axis direction is shorter than the interval between the outer peripheral surface 86p of the flange 86 and the screw 82 in the Z-axis direction, the deflection of the adjustment member 80 during the movement in the Z-axis direction can be sufficiently suppressed. In this way, according to the embodiment, it is possible to adjust the position of the head module 46 with respect to the carriage 44 with higher accuracy in the Y axis direction.

In the configuration of the inkjet image forming apparatus 10 according to the present embodiment, as described above, the amount of movement of the head module 46 in the Y-axis direction is smaller than the amount of movement of the adjustment member 80 in the Z-axis direction. Therefore, according to the embodiment, it is possible to easily adjust the position of the head module 46 in the Y axis direction with respect to the carriage 44 with high accuracy.

With the configuration of the inkjet image forming apparatus 10 according to the present embodiment, as described above, the amount of movement of the head module 46 in the Y-axis direction is proportional to the amount of movement of the adjustment member 80 in the Z-axis direction. Therefore, according to the embodiment, it is possible to easily adjust the position of the head module 46 in the Y axis direction with respect to the carriage 44 with high accuracy.

With the configuration of the inkjet image forming apparatus 10 according to the present embodiment, the presser 92 presses the head module 46 toward the carriage 44 by the elastic force. Therefore, according to the embodiment, it is possible to suppress the positional deviation of the head module 46 with respect to the carriage 44.

Although embodiments of the present invention have been described and illustrated in detail, the disclosed embodiments are made for purpose of illustration and example only and not limitation. The scope of the present invention should be interpreted by terms of the appended claims.

What is claimed is:

1. An inkjet image forming apparatus comprising:
a head module provided on a mounting base so as to be positionally adjustable in a first direction;
an adjustment member that is provided on the mounting base so as to be movable in a second direction intersecting the first direction, adjusts a position of the head module in the first direction, and includes an abutting portion that abuts an abutted portion on a side of the head module; and
a first biasing member that biases the abutted portion toward the abutting portion,
wherein at least one of the abutted portion and the abutting portion is an inclined surface inclined with respect to the second direction such that a movement of the adjustment member in the second direction is converted into a movement of the head module in the first direction.

2. The inkjet image forming apparatus according to claim 1, further comprising a second biasing member that biases the abutting portion toward the abutted portion.

3. The inkjet image forming apparatus according to claim 1, wherein the first direction is a sub-scanning direction.

4. The inkjet image forming apparatus according to claim 3,
wherein the head module includes a first positioning pin that engages with a first positioning hole provided in the mounting base, and
wherein a movement of the head module in the sub-scanning direction is converted into a rotational movement about the first positioning pin.

5. The inkjet image forming apparatus according to claim 4, further comprising a positioning member that is provided in the mounting base so as to be movable in the sub-scanning direction and includes a second positioning hole,
wherein the head module includes a second positioning pin that engages with the second positioning hole of the positioning member, and
wherein a portion of the positioning member is the abutted portion.

6. The inkjet image forming apparatus according to claim 5, wherein the second positioning hole is an elongated hole extending in the main scanning direction.

7. The inkjet image forming apparatus according to claim 1,
wherein the abutted portion is an inclined surface inclined with respect to the second direction, and
wherein the abutting portion is an R surface, an edge, or an inclined surface inclined in a direction opposite to the inclined surface of the abutted portion.

8. The inkjet image forming apparatus according to claim 7, wherein in a case where the abutting portion is an R surface or an edge, a hardness of the abutted portion is higher than a hardness of the abutting portion.

9. The inkjet image forming apparatus according to claim 1, wherein the adjustment member has a screw that screws into a screw hole provided in the mounting base, and the adjustment member moves in the second direction by a rotating operation of a tool that is connected from one side or the other side in the second direction.

10. The inkjet image forming apparatus according to claim 9, wherein the adjustment member includes a fitter that is fitted into a fitting hole provided in the mounting base so as to be movable in the second direction.

11. The inkjet image forming apparatus according to claim 10, wherein a distance between the abutting portion and the fitter in the second direction is shorter than a distance between the abutting portion and the screw in the second direction.

12. The inkjet image forming apparatus according to claim 1,
wherein the adjustment member includes an annular flange, and
wherein an outer circumferential surface of the flange is the abutting portion.

13. The inkjet image forming apparatus according to claim 1, wherein a movement amount of the head module in the first direction is smaller than a movement amount of the adjustment member in the second direction.

14. The inkjet image forming apparatus according to claim 1, further comprising a presser that presses the head module toward the mounting base by an elastic force.

15. The inkjet image forming apparatus according to claim 14,
wherein the pressing force of the presser is set to a pressing force that does not hinder the position adjustment of the head module in the second direction, and
wherein a movement amount of the head module in the first direction is proportional to a movement amount of the adjustment member in the second direction.
